(19) United States
(12) Patent Application Publication
(10) Pub. No.: US 2008/0048455 A1
(43) Pub. Date: Feb. 28, 2008

(54) Energy capture in flowing fluids

(76) Inventor: Matthew Eli Carney, Oakland, CA (US)

Correspondence Address: BIRCH STEWART KOLASCH & BIRCH, PO BOX 747, FALLS CHURCH, VA, 22040-0747, US

(21) Appl. No.: 11/509,667

(22) Filed: Aug. 25, 2006

(51) Int. Cl. F03B 13/00; H02P 9/04

(52) U.S. Cl. 290/54

(57) ABSTRACT

A system according to the exemplary embodiment of this invention includes a bluff body coupled to a gyroscopic electrical generator. The bluff body interacts with the fluid stream and generates a series of oscillating pressure gradients trailing along the leeward side, known as the von Karman Vortex Street. Motion is induced upon the bluff body by these shedding vortices. The systems and methods of the invention take advantage of this fluid behavior and convert a portion of the fluid stream energy into oscillatory mechanical energy. An exemplary electric generation system embodiment based on a gyroscope performs complimentary with the oscillatory motion of the vortex induced oscillations by using rotational kinematics to convert mechanical energy into electrical energy. Because the exemplary bluff body embodiment does not require spinning blades, there is minimal affect on the environment and minimal chance of harming creatures, such as birds or fish, located in the medium.

### FIELD OF THE INVENTION

The systems and methods of this invention relate to the conversion of the energy existing in the flow of a fluid medium into oscillating mechanical energy and furthermore into electrical energy.

### BACKGROUND DESCRIPTION OF PRIOR ART

The systems and methods according to this invention relate to a novel apparatus for producing a useful reciprocating force from a moving fluid and converting that motion into electrical energy. The systems and methods of this invention relate to a passive device which when placed in the cross-flow of a moving visco-elastic fluid is subject to a transverse, oscillating force. While other inventions have attempted to exploit this fluid mechanical interaction by use of an active cylindrical device placed in a fluid and used as a unidirectional energy conservation or driving force for vehicles on water, land or ice, the systems and methods of this invention combine those theories with gyroscopic dynamics to harvest energy from low velocity fluid streams.

One example of another invention is shown in Flettner U.S. Pat. No. Re. 18,122 of 1931 where the “Mangus Effect” and boundary layer condition is utilized by actively rotating a cylinder. That is, the relative vector motion of the fluid with relation to the cylinder skin combine to compress and decompress the fluid, by means of visco-elastic fluid behavior, on the side of the cylinder transverse to the fluid direction; effectively creating low and high pressure zones, lift or driving force. This system however requires the use of bulky and complex mechanical systems which produce the rotational motion of the cylinder.

An improvement to the well known Flettner device was introduced by Theodore Von Karman et al. U.S. Pat. No. 2,713,392, granted Jul. 19, 1955, and pertains to increasing efficiency by actively affecting the boundary layer of the cylinder skin. Von Karman suggested a porous skin for the cylinder and the application of a vacuum through a manifold interior to the cylinder and also included a directional flap mounted to the outside of the cylinder. This suction prolongs the separation point of the Karman vortex street and as such defines a larger surface for the fluid to traverse before reaching the directional flap, creating lift transverse to the direction of fluid flow. The design suggested by Karman changes the complexity of the system by not requiring rotational velocities suggested by Flettner and also significantly increases efficiency. However, the device produces a unidirectional force which does not take advantage of the natural frequency of the von Karman Vortex Street.

Yet another improvement is suggested by Jacques Y. Cousteau et al. U.S. Pat. No. 4,630,997 granted Dec. 23, 1986 in which an improved profile and permeable skin and suction system is described. This system also uses internal fans or other means to reduce the pressure within the cylinder profile, thereby controlling flow of the boundary layer around the surface of the body. Cousteau describes the use of such a system to enhance the energy efficiency of a water based ship and suggests its potential use to generate electrical energy. Again, the unidirectional force does not take advantage of the natural frequency of reciprocating motion and the potential for increased efficiency.

Each of the above mentioned patents describes using a cylinder-like shape to induce a pressure differential in a moving free stream fluid thereby generating a force in a single direction. Michael L. Fripp et al., in U.S. Pat. Application Publication No. US 2005/0230973, describes a device which generates electrical power by way of flowing fluid induced vibrations. The patent application explains that vibration of a member or assembly due to fluid flow impinging on the assembly is known in the art and while generating electricity from vibration motion is also known, minimizing the obstruction of fluid flow continues to require improvement. The topics are based on the well known von Karman Vortex Street and its affect on vibration of assemblies placed in flow. It appears the discussion of Fripp is concerned with flows internal to a pipe or fluid transport system and his emphasis is on minimizing the obstruction of flow while effectively utilizing energy available in the flow by using a lift reversal device, such as a flexible member. The system described by Fripp also includes generating electricity by attaching a series of magnets and coils to the end of the vibrating body. This device is quite similar to that described within my patent however it does not take advantage of the natural frequency of oscillation of both the vibrating member and an electric generation system described herein which includes a high energy efficiency rotating flywheel.

Transforming vortex induced vibrations into electromagnetic force can be performed by coupling a gyroscope to the oscillating member. Similar to the configuration described by Herbert and Georg Sachs in U.S. Pat. No. 4,352,023 issued on Sep. 28, 1982; a gyroscope can be used to transform oscillation or reciprocating motion into electrical energy. Sachs explains a mechanism which rides on the surface of ocean waves and transforms the periodic motion of waves into electrical power. The electrical generator of the system is composed of a high rotational speed flywheel generator mounted in a set of fixtures supported by a series of two gimbals arranged orthogonally to one another. The dual gimbal arrangement of the gyroscope is capable of translating single degree motion from a given direction into rotational motion of the inner most flywheel generator. Sachs envisions a mechanism which floats on waves and translates motion from two perpendicular directions into electrical energy. The device is a novel approach to generating power from waves however the turbulence of wave motion could affect the efficiency of the system by occasionally transmitting forces which counteract or decrease the rotational velocity of the flywheel generator.

The systems and methods of the invention described herein also exploit the kinematics of gyroscopic force translation by coupling a gyroscope to the oscillatory motion induced upon the bluff body by vortex shedding. Rather than sit upon the waves, the gyroscope is coupled to a bluff body which is submerged in a unidirectional fluid flow. The systems and methods of the invention take advantage of the same von Karman Vortex Street and vortex induced vibrations as described by the above patents, however it is coupled to a highly efficient gyroscopic flywheel system; and thereby taking advantage of the efficiency of both sets of novel systems, fluid and kinematic. Additionally, there are no rotating blades merely oscillating bodies which convert unidirectional fluid flow into turbulent flow, greatly reducing impact on the environment. The elegance of the systems and methods of the invention is due to the simplicity of conservation of energy. Fluid inertia leads a physical body into a dance at its own natural frequency. This natural vibration is coupled to another dynamic system whose own natural frequency of vibration can be tuned to match that induced by the fluid. As these two unique features step in tune with one another they complete a path through which energy can elegantly transform from fluid to electric with minimal impact on its surrounding environment.

### BRIEF SUMMARY OF THE INVENTION

This invention provides a necessary means to convert low velocity fluid energy into electrical energy with minimal impact on the environment. Although low velocity fluid may not appear to contain substantial energy, a system such as thus described can generate a significant amount of energy with widespread and prolonged use.

Additionally, the modern structure of world power generation will no longer depend on a few independent power plants, but instead a diverse and distributed power system, which includes various modes of extracting energy. In some instances it may prove worthwhile to construct large scale energy farms consisting of large arrays of the invention described above, placed in long-term predictable ocean, tidal or river currents. In other instances specially tuned version of the above invention may be distributed throughout providing energy to remote locations.

The systems and methods of the invention described herein involve a novel combination of mechanisms that when arranged in such a fashion as described is able to translate energy embodied in a flowing fluid into electrical energy. Two principal components are combined in a novel arrangement which exploits two seemingly unrelated behaviors of mechanics. In one exemplary embodiment of the systems and methods of the invention, the first component is a bluff body, a geometric shape which redirects a fluid streamline. As fluid traverses the surface of the bluff body vortices shed off the leeward end of the body at a consistent and predictable frequency, known phenomenon is described as the von Karman Vortex Street. This interaction between fluid and bluff body induces a periodic oscillation on the body by way of pockets of pressure differentials floating along the fluid stream. In this exemplary embodiment, the second component consists of a flywheel generator connected to a series of two perpendicular stages of gimbals, as in the configuration of a gyroscope. Oscillating motion at the outer stage is transferred to rotational motion of the innermost flywheel stage by way of rotational inertia kinematics and the theory of conservation of momentum. When the body and gyroscope are coupled together the motion of the bluff body provides motion to the outer stage of the gyroscope, as such this coupling between bluff body and gyro provides a path for energy transmission directly from fluid to electricity by way of a gyroscopic flywheel electrical generator.

The bluff body consists of a three-dimensional physical object that obstructs a fluid streamline when placed in cross flowing fluid. The geometry of such an object would be circular in its most basic exemplary embodiment although it could be rectangular, triangular, trapezoidal or any other object whose geometry is contoured, as has been shown in other similar constructions. The circular exemplary embodiment can itself hold the form of circular cylinder or sphere, where geometry induces different yet consistent modes of oscillation.

The driving principle of this oscillation is known as the vortex induced vibration. These vortices form when a visco-elastic fluid flowing across an appropriately contoured body will begin to shed turbulent eddies, forming a wake of varying pressure zones. These eddies are formed when fluid sticks to the surface of the bluff body, while also being pulled along by the flowing stream a distance away from the body. Rotational turbulence begins to form as the free stream drags the fluid leeward from the contoured surface. Eddies whose sum pressure is less defined than that of the free stream, generate a wake of low pressure pockets or zones trailing the bluff body. The fluid flow whose inertial and viscous properties can be characterized by the non-dimensional Reynolds number will actually transmit pressure variations onto both axially symmetric downstream sides of the bluff body. When the fluid flow regime exhibits a Reynolds number within a widely defined range, a behavior of fluid mechanics known as the von Karman Vortex Street is exhibited. The trailing wake displays a steady frequency of vortex shedding directly related to the fluid flow. Another non-dimensional number, the Strouhal Number, directly relates the frequency of this von Karman Vortex Street to the fluid velocity and bluff body geometry. When the frequency of vortex shedding nears the natural frequency of the bluff body or attached objects the alternating pressures can induce significant vibrations or oscillations in the bluff body.

Modifying the geometry and stiffness of the bluff body affects the modes of oscillation that are induced upon it. When the bluff body is, for example, a circular cylinder it is subjected to alternating lift forces along the length of the body. The body, when constrained in both the x and y directions (transverse to flow and downstream, respectively) will begin to rotate about its own vertical axis. A splitter plate, which may be, for example, a thin object opaque to pressure gradients, extending down the length of the cylinder, and may, for example, be located behind the cylinder to further increase the moment arm of this lift force and also affect the separation point of turbulent eddies. Alternatively, if the body is constrained in the x-direction (downstream) and constrained to some extent from rotation, it will begin to vibrate in a direction transverse to the free stream flow.

A bluff body consisting of a sphere tethered to a base will have its own unique mode of oscillation. A tethered sphere will vibrate through a pattern similar to a figure-eight, elongated in the direction transverse to the free stream. The y-directional (transverse to flow) motion exhibits a motion significantly more pronounced than that in the x-direction, and its amplitude and frequency is dependent upon geometry and flow behavior. As such, a sphere tethered by a rigid member will transmit a torque force to its base. Additionally, a sphere tethered by a semi-rigid member will oscillate in a fashion similar to a sphere and cylinder.

As vortices shed off of bluff bodies they translate the energy contained in the unidirectional free stream flow into turbulent eddies that produce periodic lift forces on objects opaque to pressure, inducing transverse or rotational motion which can be more readily extracted by mechanical systems. In various exemplary embodiments of the invention, the energy imparted into the motion of the bluff body can be transmitted through a coupling to a gyroscopic generator.

In various exemplary embodiments of the invention, the gyroscope consists of a flywheel electronically triggered as either a generator or motor and mounted in a series of two perpendicular stages of gimbals. The benefit of generating power from a flywheel is that it retains a substantial amount of rotational inertia or rotational energy. Where the electrical generation systems described by Fripp transforms power linearly, the rotational power of the flywheel is transformed in a quadratic fashion. Initially the flywheel acts as a motor and draws current to spin up to speed. The rotational inertia of a gyroscope is conserved through kinematics, so that motion imparted on the frame is transmitted through the intermediate frame to affect the rotational velocity of the innermost flywheel. When timed properly an external force applied to the outer frame will induce a rotation of the intermediate frame which, in turn, transmits a propulsive force to the rotating flywheel, accelerating the flywheel. Controlling the electronic load of the flywheel will draw the excess rotational velocity of the flywheel as electrical force. By balancing the input of rotational energy and electrical load, one can equilibrate the rotational velocity of the flywheel and hence the input/output of the system. Therefore, energy that is imparted onto the frame of the gyroscope can be extracted as electrical energy through the generator flywheel. Exemplary systems of this type complete a direct conversion from mechanical force to electromotive force by converting the excess rotational energy of the flywheel to electrical energy.

In various exemplary embodiments of the invention, an electronic control and coupling system can be used to combine the two principle systems described above into a direct pathway for converting fluid energy into electrical energy. The force transmitted from the fluid to the bluff body can be coupled to the outer frame of the gyroscope. Since the von Karman Vortex Street induces regular, periodic oscillations in the bluff body, the rotational velocity of the flywheel can be electronically adjusted to coincide with that of the coupled bluff body oscillation. When the oscillation of the bluff body is coupled to the tuned oscillation of the gyroscope frame energy can transmit directly from the fluid into the rotation of the flywheel, where excess rotational force is instantaneously extracted as electrical energy.

In the various exemplary embodiments of the invention, the bluff body directly converts flowing fluid energy into mechanical energy and the gyroscopic generator directly converts mechanical energy into electrical energy. Other exemplary embodiments create the pathway and corresponding structure through which the energy may travel from fluid to electricity. An electronic control system may be provided to manage the coupling between the bluff body system and the gyroscopic generator system. When placed in a fluid traveling at a given velocity the bluff body will oscillate at a relatively consistent frequency. The control system tracks the frequency of oscillation of the bluff body. Simultaneously the control system tracks the rotational velocity of the gyroscope generator. If the gyroscope is out of phase from the bluff body the control system regulates the flywheel rotational velocity to match that of the bluff body. If the gyroscope and the bluff body are too far out of phase the coupling may be disengaged until their phases are close enough for the control system to engage the power transmission coupling. In various exemplary embodiments, the control system regulates the rotational velocity of the flywheel by switching its operating mode between motor and generator, the flywheel is accelerated by sending current through the coiled wires of the flywheel system, acting like a motor, and the flywheel is decelerated by drawing current through the coiled wires of the flywheel system, acting like a generator. In various exemplary embodiments of the systems and methods of the invention, the torque energy passed from the oscillating bluff body, through the power transmission coupling to the external gyroscope frame accelerates the flywheel and, simultaneously, the control system draws an electric load from the flywheel generator that is equivalent to the increased rotational energy input as torque through the coupling. In various exemplary embodiments, in steady state operation, the control system draws just as much energy from the gyroscopic flywheel generator as it realistically can from what is input from the fluid stream, equilibrating the path from fluid energy to electrical energy. This invention embodies the various exemplary embodiments of the systems just described as a way of extracting electrical energy from flowing fluid mediums.

### BRIEF DESCRIPTION OF THE DRAWINGS

The following description of the figures will provide greater insight with reference to the following discussion of the preferred embodiments of this invention:

FIGS. 1A-1C are pictorial views of vortices shedding off of a bluff body of circular cross section;

FIG. 2a is a perspective view of a circular cylinder bluff body with an attached splitter plate, shedding vortices, constrained to rotate about its own vertical axis;

FIG. 2b is a perspective view of a circular cylinder bluff body with multiple attached splitter plates, shedding vortices, constrained to rotate about its own vertical axis;

FIG. 3 is a perspective view of a circular cylinder bluff body, shedding vortices, constrained to oscillate in the direction transverse to fluid flow;

FIG. 4 shows a cross-sectional cut-away view of a spherical bluff body attached to a base and able to rotate about the x-axis of the base including an exemplary arrangement of a gyroscopic generator;

FIG. 5 shows a cross-sectional cut-away view of the system of FIG. 3 including an exemplary arrangement of a gyroscopic generator;

FIG. 6 shows a perspective view of a circular non-cylindrical bluff body attached to a base via a shaft where the shaft is movable in a direction other than the direction of wind flow;

FIG. 7 is a partially schematic perspective cut-away view of the system shown in FIG. 6;

FIGS. 8 and 9 are cross-sectional cut-away views of various exemplary embodiments of systems employing a spherical bluff body attached to a support member coupled to a generator;

FIG. 10 is a cross-sectional view showing the arrangement of an exemplary embodiment of a gyroscopic generator and coupling;

FIG. 11 is a block diagram of an exemplary embodiment of a control system used in this invention.

### DESCRIPTION OF THE EXEMPLARY EMBODIMENTS

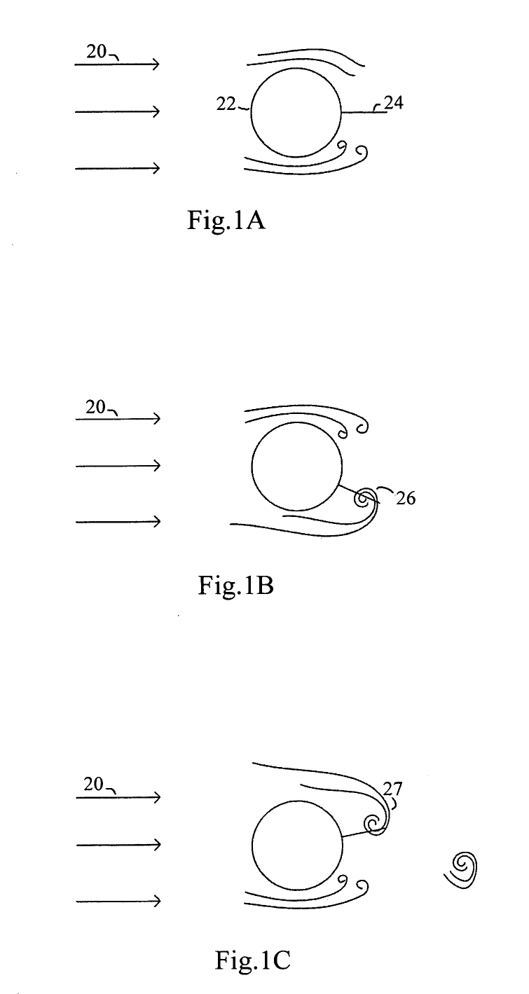

Before describing exemplary embodiments of this invention, the underlying principles of fluid behavior around a bluff body will be explained. The exemplary embodiments involved with the fluid interaction will be described, followed by a description of a generator and various exemplary embodiments of a generator. A coordinate system is used as a convention for better understanding and is defined from FIG. 1. The direction of the free stream fluid flow 20 in the plane of the drawing is referred to as the x-coordinate. The y-coordinate is that direction orthogonal to the free stream flow 20 in the plane of the drawing. The z-coordinate extends perpendicular to the plane defined by the y and x axis and is not located in the plane of the drawing but intersects that plane.

FIGS. 1A-1C shows the fluid flow around a sample bluff body with a circular cross sectional shape. The cross sectional shape of the bluff body 22 may be triangular, rectangular, circular, trapezoidal or have some other geometrical cross section, and may have a contoured surface and may vary in thickness in the y, and/or x and/or z axes, however for simplicity of explanation of the concepts the figures show a generally circular cross sectional shape. Included in this figure is a splitter plate 24 directly downstream of the cylinder in FIG. 1a. This plate 24 is shown for descriptive purposes as being part of the buff body 22, however it is present in some of the following embodiments as an attachment to the cylinder, and may be directly attached to the buff body 22 or attached indirectly to the buff body 22, and also can be embodied in a location at some point downstream of the cylindrically shaped bluff body 22 separate and apart from the buff body 22.

FIG. 1A shows the free stream flow 20 deflecting around the bluff body 22. In this FIG. 1a fluid is just beginning to curl around the curved contour of the bluff body 22. The pressure is symmetric across the x-axis leaving the splitter plate 24 aligned with the x-axis in a neutral position.

FIG. 1B shows turbulence curling about itself forming into a vortex 26. These vortices 26 develop when a visco-elastic fluid sticks to the surface of the bluff body 22, while also being pulled along by the flowing stream 20 a distance away from the body. Rotational turbulence begins to form as the free stream drags the fluid away from the contoured surface. These turbulent eddies whose sum pressure is less defined than that of the free stream, generate a wake of low pressure zones trailing the bluff body. With the pressure inside the vortex lower than that of the free stream, a lift force is created on an object situated within this pressure gradient. The splitter plate 24 is pushed into the low pressure vortex 26 in FIG. 1B by the nominal pressure of the free stream.

As shown in FIG. 1C the viscosity of the free stream 20 continues to drag the vortex behind the bluff body 22, and the low pressure contained within the vortex 26 helps form the next turbulent eddy 27 on the opposite side of the x-axis. When this new vortex forms in FIG. 1C the splitter plate 24 is pushed above the x-axis by the pressure gradient.

This wake pattern of vortex shedding from opposite downstream sides of the bluff body is known as the von Karman Vortex Street. The formation frequency of the vortex wake becomes quite stable throughout a wide range of fluid flow conditions and can be characterized by the Strouhal number, which relates frequency to bluff body geometry and flow conditions. The von Karman Vortex Street generates periodic lift forces on the bluff body 22 and splitter plate 24 thereby inducing oscillating motion and translating the energy contained in a unidirectional flowing fluid 20 into an oscillating mechanical energy. The following will describe various systems and methods of using this phenomenon of fluid-solid interaction to generate constrained modes of oscillation which can then be coupled to a system converting mechanical energy into electrical energy, thereby completing an energy conversion path from fluid to electrical energy.

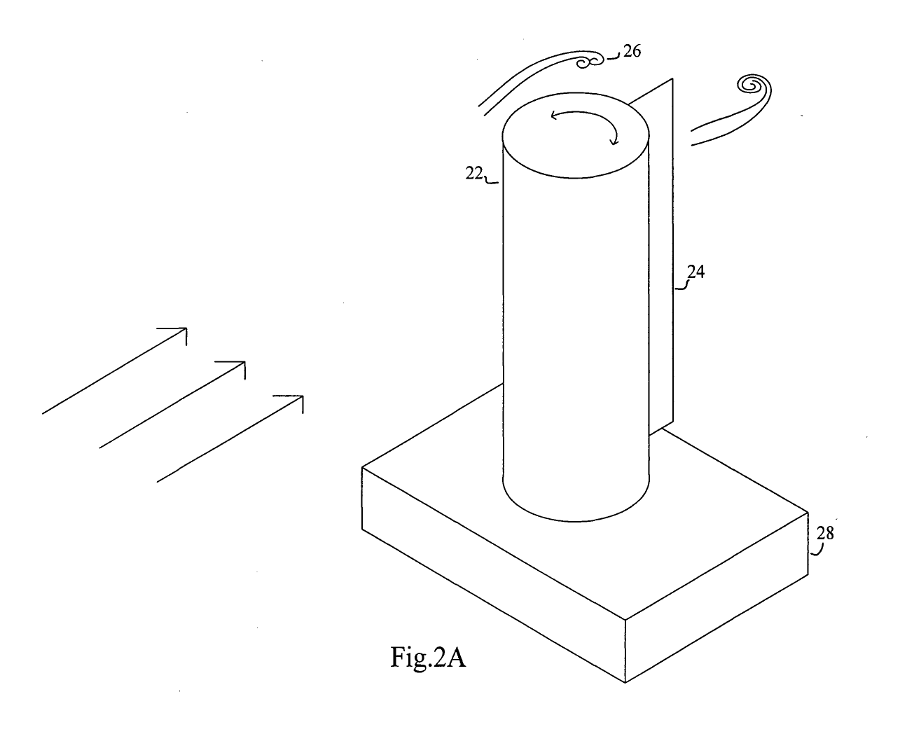

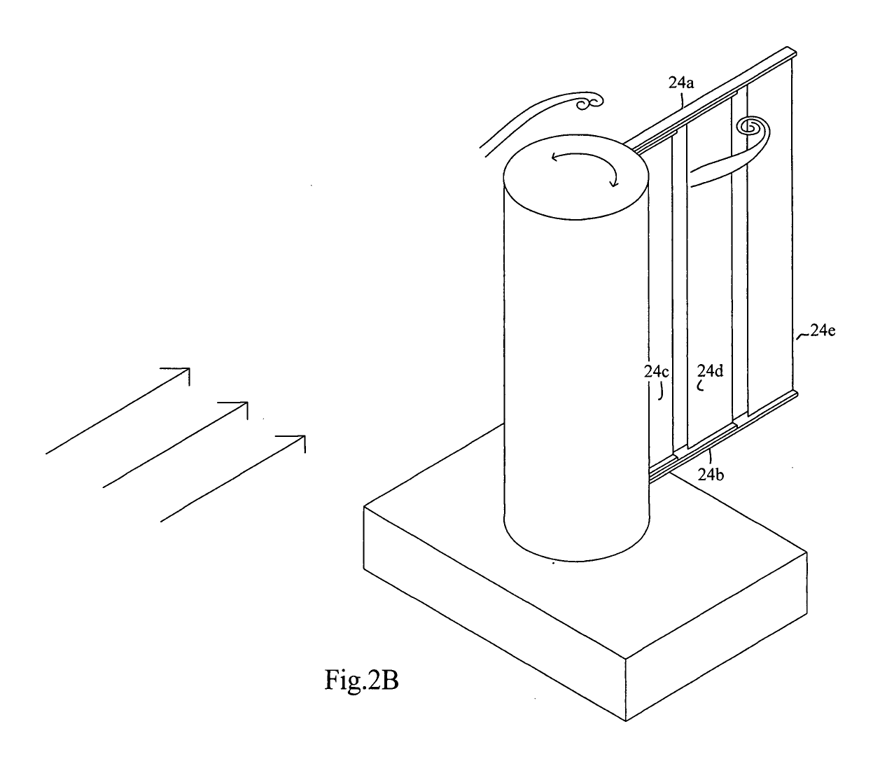

FIGS. 2A and 2B are perspective views of a bluff body 22 extended in the z-direction as a freely rotatable circular cylinder bluff body 22 mounted on a base 28. It should be noted that although the drawing figures in this application visualize the energy conversion system in a vertical arrangement with bases 28 located on the bottom of the images, this invention may be arranged in numerous orientations depending on the application. Additionally, although a base 28 is only shown on one end of the bluff body 22, there may be cases where additional stability and fluid control is required and bases are attached to both ends of the bluff body 22.

The free stream fluid flow 20 is visible and vortices 26 are also shown shedding off the bluff body 22 in FIGS. 2A and 2B. A splitter plate 24 is also shown downstream of the bluff body 22, although in various exemplary embodiments of the systems of the invention this splitter plate 24 may vary in size and/or shape or may not be provided. Also in this exemplary embodiment, the splitter plate 24 is shown attached to the circular cylinder bluff body 22. However, various exemplary embodiments will use the cylinder stationary and the splitter plate freely rotatable, while others may use the splitter plate freely rotatable located or extending a distance downstream of the bluff body 22, thereby increasing the moment arm. Further exemplary embodiments of the systems of the invention may include multiple freely rotatable splitter plates 25 as shown in FIG. 2B. The splitter plate exemplary embodiment shown in FIG. 2B has upper and lower frame members 24a and 24b and plates 24c-24e, that are separated by gaps therebetween. In various exemplary embodiments, the plates may have various heights, thicknesses and widths and subsections and may be movable and/or stationary and may pivot vertically and/or horizontally.

The exemplary embodiment of the invention shown in FIGS. 2A and 2B involves a bluff body 22 constrained in the y and x directions, leaving only rotation about the z-axis as the single degree of freedom. As vortices 26 shed off the bluff body 22 the pressure gradient induces lift force on the bluff body 22 or splitter plate 24 or splitter plates 25. Due to the translational constraints in the y and x direction, the bluff body 22 or splitter plate 24 or splitter plates 25 is forced to oscillate about its own z-axis.

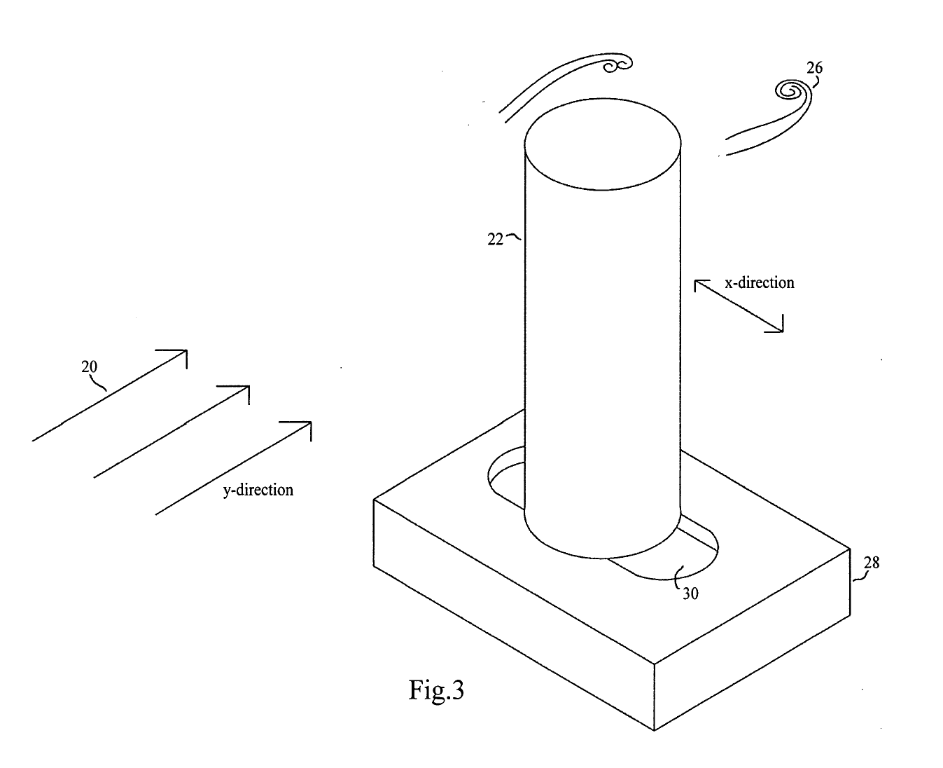

FIG. 3 shows a cutaway view of the systems shown in FIGS. 2A and 2B. It should be noted that the representation of FIG. 3 and FIGS. 2A and 2B exemplifies the best mode of using this invention as seen by the inventor, although it is only one method of performing the function of supporting a rotationally oscillating bluff body and splitter plate and coupling it to an electrical generator, and a person of ordinary skill in the art should be able to develop other means to perform this task. In this exemplary embodiment, it can be seen that the bluff body 22 is supported by a series of bearings 44 that constrain motion to rotation about the center z-axis. A shaft 50 attached to the bluff body 22 transmits force to an electrical generator gyroscope 42 through a power transmission coupling 46. It should be noted that although wiring and electronics are not shown in detail in FIG. 3 they are indeed necessary to transmit electromechanical controls and also electrical power, and are indicated, generally, by element 48.

In various exemplary embodiments of the systems and methods of the invention, the construction of the power transmission coupling may take a plurality of forms. One such method of power transmission includes an electromechanically actuated disc and caliper coupling system. Those skilled in the art should be able to specify a plurality of suitable means of transmitting oscillating motion from a shaft to an oscillating frame. The rotational inertia of the transmission coupling 46 should be minimized to reduce rotational inertial resistance to the oscillating nature of the bluff body and generator system.

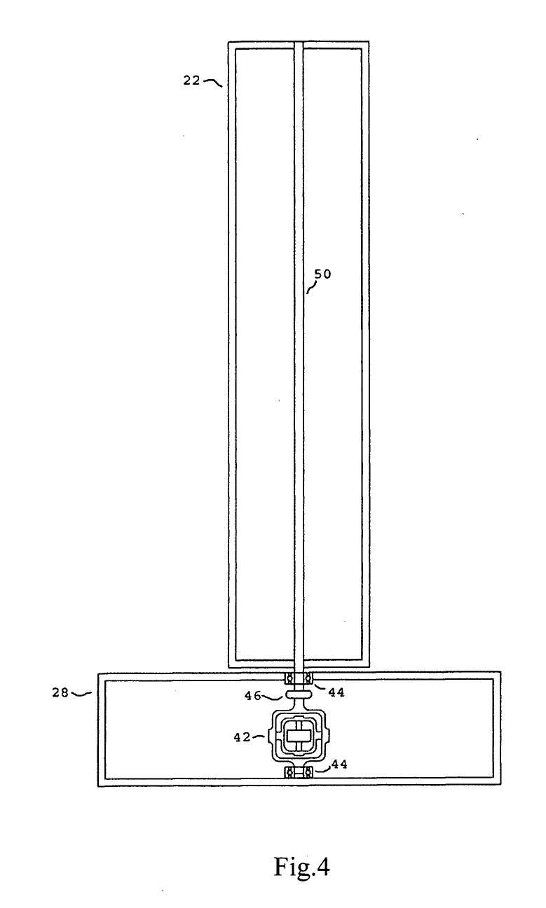

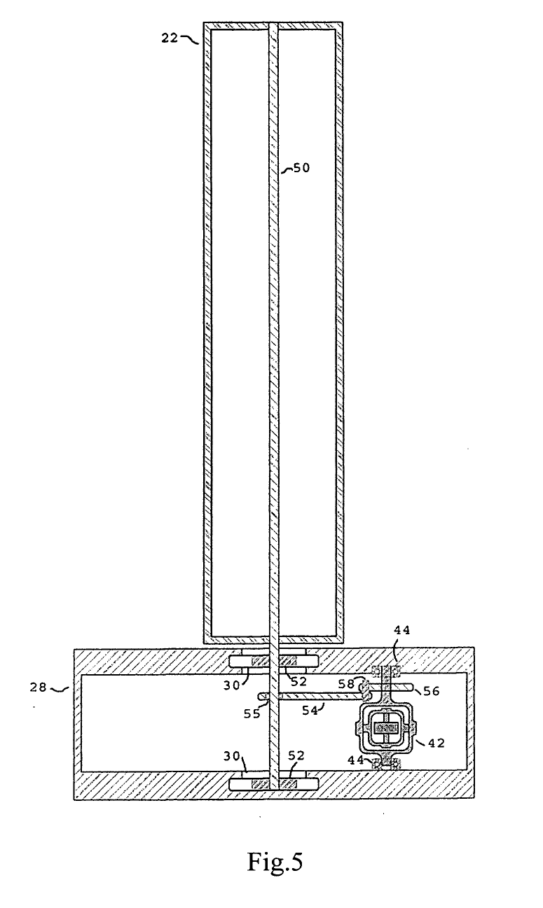

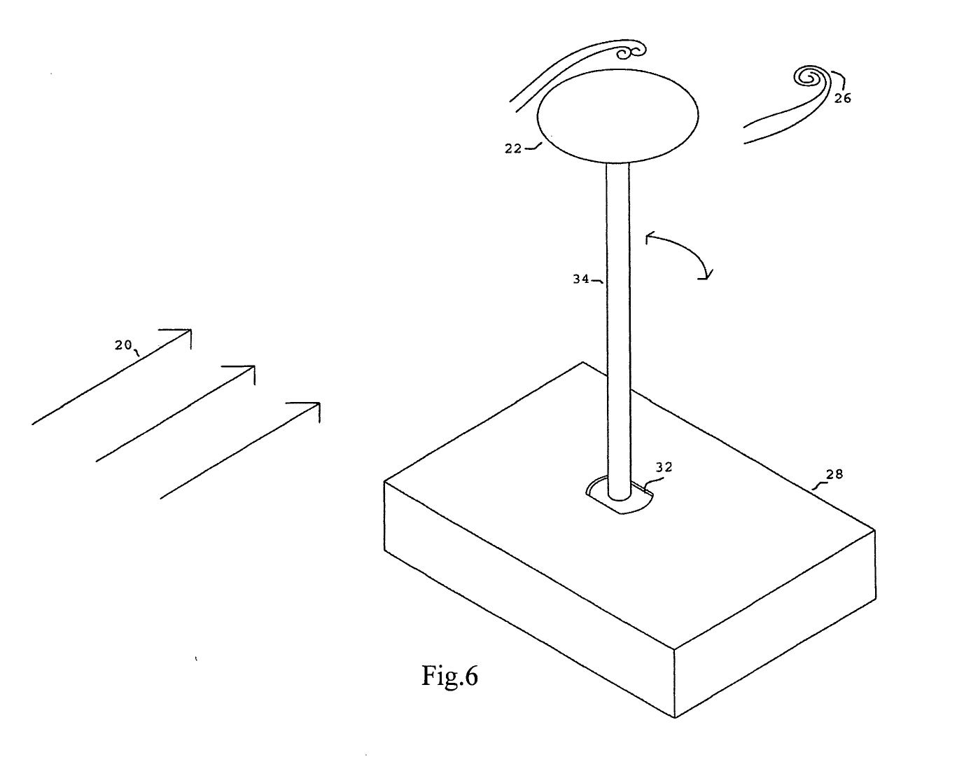

The exemplary embodiment in FIG. 4 includes a bluff body 22, mounted on a base 28, shedding vortices 26. However, this exemplary embodiment is only constrained in the x-direction and is free to translate along the y-direction. A channel 30 exists in the base 28, allowing motion along the y-direction. The bluff body 22 can be freely rotatable and although not pictured, may have an attached splitter plate. In this exemplary embodiment the bluff body 22 is coupled to an electrical generator through a power transmission coupling 46, shown in FIG. 5, for example, that converts translational motion into rotational motion. One skilled in the art could specify a means of a power transmission system coupling the bluff body 22 and electrical generator 42, shown in FIG. 5 for example.

FIG. 5 is a cutaway view of the translational bluff body system shown in FIG. 4. The bluff body 22 is attached to a drive shaft 50 which extends within the base 28. A set of linear bearings 16 constrain the shaft 50 to motion in the y-direction. The bearings and shaft are free to move linearly through a channel 30 which exists within base 28. A crank arm 54 is mounted to the drive shaft by a crank bearing 55. The crank arm 54 is then coupled through a power transmission 58 to a coupling arm 56. The crank arm 54 and power transmission coupling convert translational motion into oscillating rotational motion. The oscillating rotational motion is then transferred to an electrical generator 42 by the attachment of coupling arm 56. The electrical generator 42 is supported by bearings 44. The arrangements of mechanisms shown in FIG. 5 are only to assist in the understanding of coupling translation to rotational motion. Various other methods of and systems for converting translational motion to rotary motion may be used in lieu of or in addition to the arrangements shown in FIG. 5.

The exemplary embodiment of FIG. 6 shows a perspective view of a bluff body 22 immersed in a free flowing fluid 20, and shedding vortices 26. However, the bluff body 22 does not have an extended cylindrical shape as shown in FIGS. 2A, 2B and 3. The bluff body 22 in FIG. 6 has a circular cross-sectional disc shape but a spherical shape may also be used. The bluff body 22 is attached to a support arm 34. The bluff body 22 may be connected at an end of the support arm 34 or the support arm may penetrate into and/or through the bluff body 22. The bluff body 22 sheds vortices in a fashion similar to that shown in FIG. 1, however due to the curvature of the disc-shaped or spherical shaped bluff body 22, the motion induced upon the spherical bluff body 22 is slightly different than that induced upon a circular cylinder. The vortices shed from the bluff body 22 may induce a figure eight motion elongated in the direction transverse to free flow with a very minimal forward backward motion. The bluff body 22 mounted on support arm 34 is constrained to rotational motion about the x-axis while allowing minimal rotation about the y-axis. A rotational channel 32 is built into a base 28 to allow oscillating rotational motion about the x-axis.

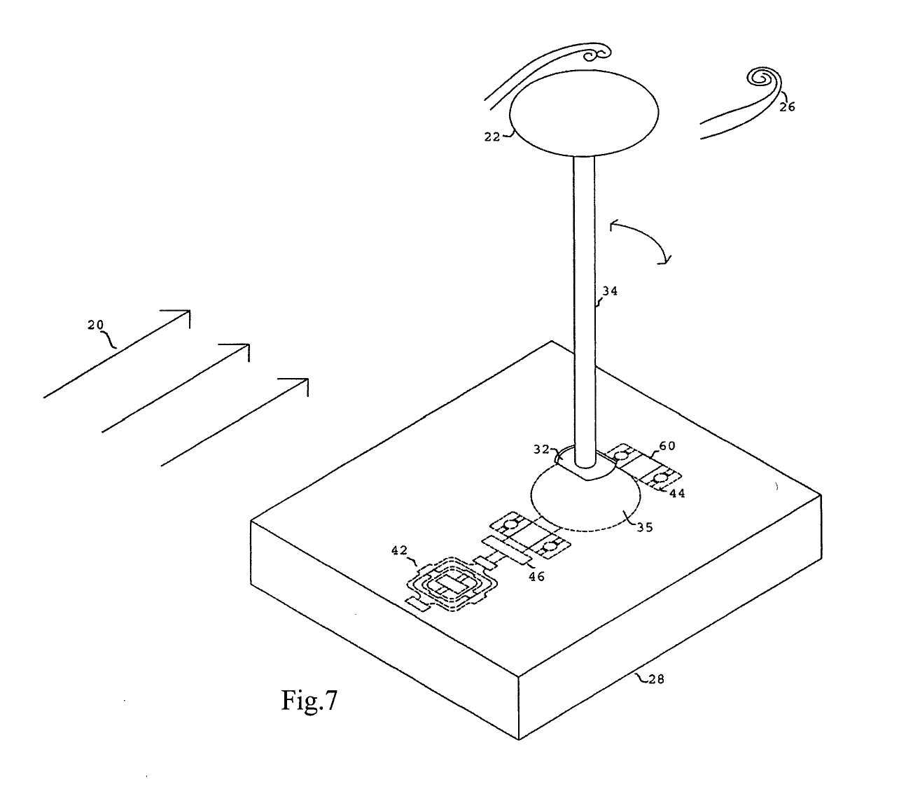

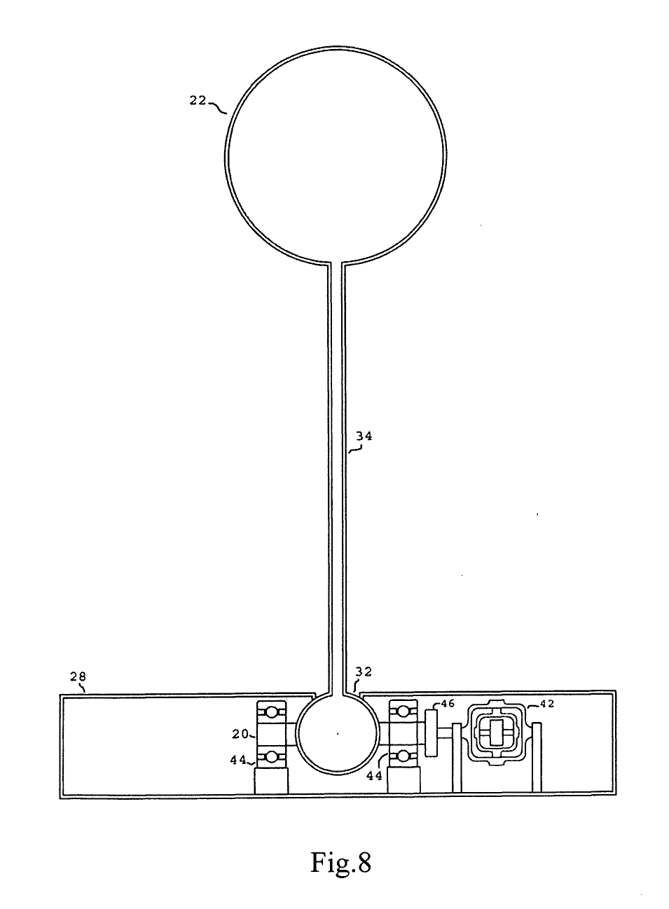

FIGS. 7 and 8 are partially schematic perspective views of the mechanism shown in FIG. 6, with a perspective view of the internal mechanisms and a cutaway view of internal mechanisms, respectively. The support arm 34 is attached to a support arm bearing 35 that extends through a channel 32 located in a base 28. This support arm bearing 35 is attached to a horizontal drive shaft 60. The drive shaft is supported by bearings 44. The drive shaft is coupled to an electrical generator 42 by means of a power transmission coupling 46. Various coupling means that are known to one of ordinary skill in the art can be used with this exemplary embodiment.

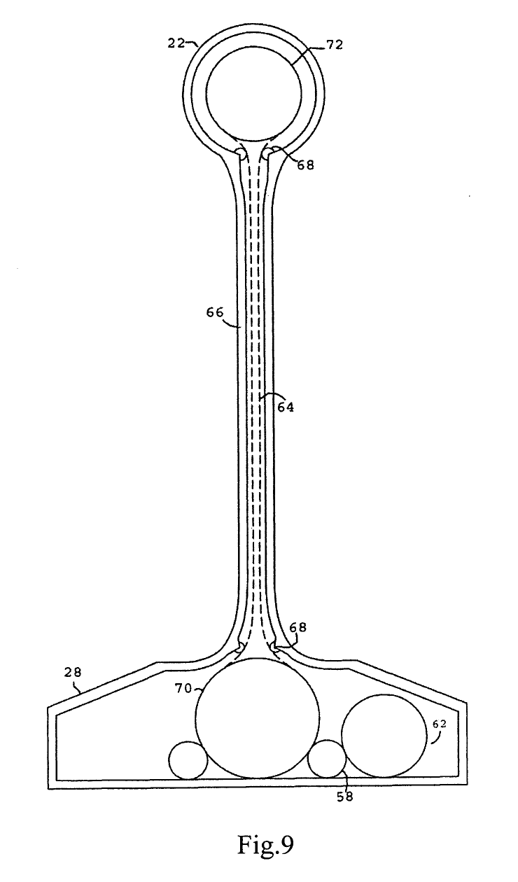

Another exemplary spherical bluff body embodiment similar to that just described above is shown in FIG. 9. In this figure a spherical bluff body 22 is supported by a flexible support shaft 66. The support shaft is mounted to a base 28. Similar to the spherical bluff body described above, the spherical nature of the bluff body 22 induces vortex shedding that causes the bluff body 22 to move in a figure eight motion elongated transverse to the free stream flow. The rigidity of the support arm 66 can be adjusted to affect oscillation frequency by choosing materials of specific properties, such as fiber reinforced composites or plastics, piezoelectric materials or other mechanical means. This flexible shaft structure 66 can actually be constructed into three different exemplary embodiments, each of which will be shown with reference to the same FIG. 9.

The first exemplary embodiment of FIG. 9 involves the use of an electromechanical support arm 66 employing a material such as a piezoelectric polymer which converts mechanical deformation into electricity. The oscillating motion of the bluff body 22 translates based on the deformation of the support arm 66, which would then induce an electric charge which could be captured through wires (not shown) embedded in the flexible shaft structure 66.

A second exemplary embodiment of FIG. 9 involves the use of a gyroscopic generator (not shown) mounted in a housing 72, in the spherical bluff body 22. The flexible support arm 66 forces the oscillating motion of the bluff body to rotate an offset distance about the x-axis. By mounting a gyroscopic generator (not shown) in the housing 72 the oscillating motion induced by vortex shedding would cause rotation of the primary gyroscopic frame of the gyroscopic generator (not shown). This arrangement minimizes the need for complex power coupling transmissions and would effectively convert fluid energy into electrical energy in a manner similar to that shown by Sachs (U.S. Pat. No. 4,352,023). Sachs demonstrates converting the relative periodic motion of a wave induced motion into electrical energy by placing a gyroscopic generator on a platform affected by said motion.

A third exemplary embodiment of FIG. 9 involves the use of a cable system 64 to transfer the oscillating motion of the bluff body 22 through a flexible shaft 66 to an electrical generator 62 mounted in a base 28. The cable system attaches to a housing 72 inside the bluff body 22 and also to a drive roller 70 which is intermeshed with a coupling transmission 58. In various exemplary embodiments, the cable system is supported at specific locations by a series of cable bearings 68 to prevent rubbing and fraying of cables in the cable system 64. The coupling transmission 58 is also attached to an electrical generator 62. As the bluff body 22 oscillates, the cable system 64 is pulled which, in turn, rotates the drive roller 70. The coupling transmission 58 then transmits this oscillating rotational motion to the electrical generator 62, therefore completing the energy conversion path from fluid flow to flow of electricity. It should also be noted that it may also be possible to bypass the coupling transmission 58 and directly attach the electrical generator 62 to the drive roller 70.

All of the above mentioned exemplary embodiments of the systems and methods of the invention operate with the same basic principles. That is vortex shedding induces motion in a bluff body. This motion is either translational or rotational oscillation. Except in the case of the flexible Piezo electric support arm, this motion is transferred to a means of generating electricity by a form of power transmission coupling and a generator. The oscillating motion is then converted into electricity by an electrical generator.

In various exemplary embodiments of the invention, a standard electric generation system may be combined with the above disclosed systems. For example, a standard generator which consists of coiled wires passing through a magnetic field therefore having an electrical current induced in said wires. This type of device may be one in which the coiled wires and magnets are arranged in concentric rings, where continuous rotation of the magnets around the wires, or wires about the magnets produces an electromotive force. This concentric arrangement could also induce current with oscillating motion however the efficiency of alternating rotational motion may be questionable. Additionally, the magnets and wires could be arranged in a linear fashion as is used in conventional linear motor systems whereby oscillating linear motion may induce electric current flow in the form of a linear generator system.

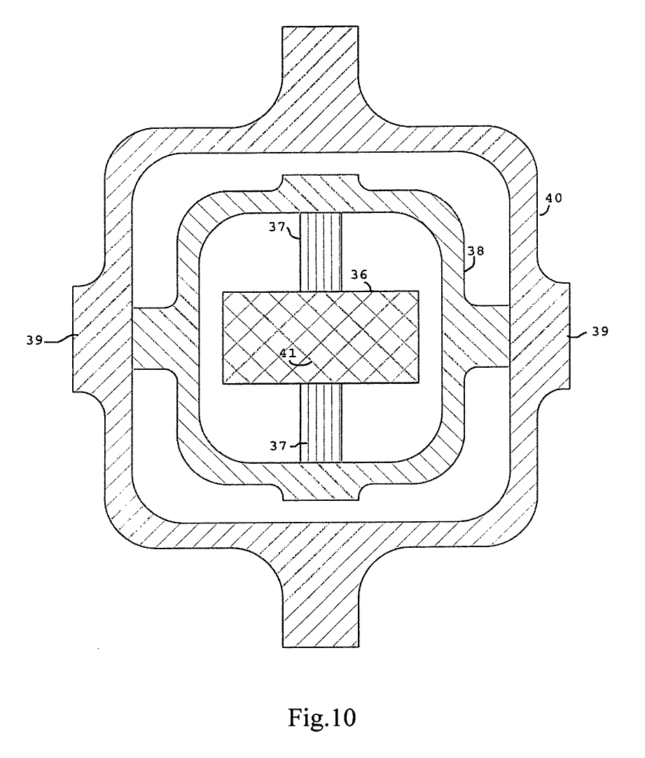

An exemplary embodiment showing how to rotate wires through magnetic fields for use with this invention is shown in FIG. 10. Although a standard electrical generating system could be coupled to the systems of the invention disclosed above, taking advantage of a kinematic phenomenon may provide significant enhancements to efficiency. FIG. 10 shows an exemplary embodiment of a gyroscopic generator 40. The gyroscope 40 consists of a flywheel rotator 36 mounted in low friction gimbal bearings (not shown). The flywheel rotator 36 itself consists of a series of wires 41 wound around the rotator 36 and a series of magnets (not shown) mounted on a stator 37, or the wires 41 may be mounted in a fixed fashion along stator 37 while magnets (not shown) are mounted to the rotator 36. The gimbal bearings (not shown) allow the rotator 36 to rotate within an intermediate frame 38, which itself is mounted via gimbal bearings 39 located perpendicular to the axis of stator 37 supporting the internal rotator 36. The gimbal bearings 39 are mounted in an external frame 42 which itself is capable of rotating about an axis defined to be vertically oriented and along the vertical midline of this FIG. 10 (set at ninety degrees rotation from those bearings 39 supporting the intermediate frame 38). This amounts to a flywheel or rotator 36 supported by two sets of gimbal bearings, those (not shown) within the rotator 36 and bearings 39 which is, by definition, a gyroscope.

The manner in which the gyroscope kinematics can be exploited is by way of conservation of rotational momentum. Vector forces will briefly be described to help explain the kinematics. An object, such as a flywheel or rotator 36, which will currently be described as a disc, with mass rotating about its own axis at a given speed will remain at this speed unless an external force is applied to it. Hence, a flywheel or rotator 36 is capable of storing a great deal of energy by rotating at high angular velocity. While the flywheel or rotator 36 is rotating a moment force vector extends from the rotational axis of the flywheel rotator 36. A force applied to the flywheel rotator 36 at ninety degrees to the axis of rotation will induce a responsive vector force ninety degrees to the plane created by the rotational inertia vector and the applied force, due to conservation of momentum. In the case of a gyroscope 40 the intermediate frame 38 that supports the flywheel 36 and stator 37 is also capable of rotating freely. Therefore the new vector force created by the application of an external force is capable of rotating the intermediate frame 38.

The gyroscope 40 has two gimbals, one (not shown) mounted within the flywheel 36 and also 39 which essentially creates two freely rotatable masses, flywheel rotator 36 and intermediate frame 38. It can be seen that applying a force to the external frame 42 will induce motion in the intermediate frame 38, which in turn induces motion on the innermost flywheel rotator 36. By matching the application of the applied external force to the rotational characteristics of the gyroscope 40 one can increase the rotational momentum of the innermost flywheel rotator 36. If an electromagnetic load is placed on the inner flywheel rotator 36, the increase in rotational energy from the applied external force can be drawn from the system 40 in the form of an electromotive force, or electrical energy. Balancing the draw of electricity from the flywheel rotator 36 or stator 37 with the applied external force creates a balanced arrangement of energy input and output.

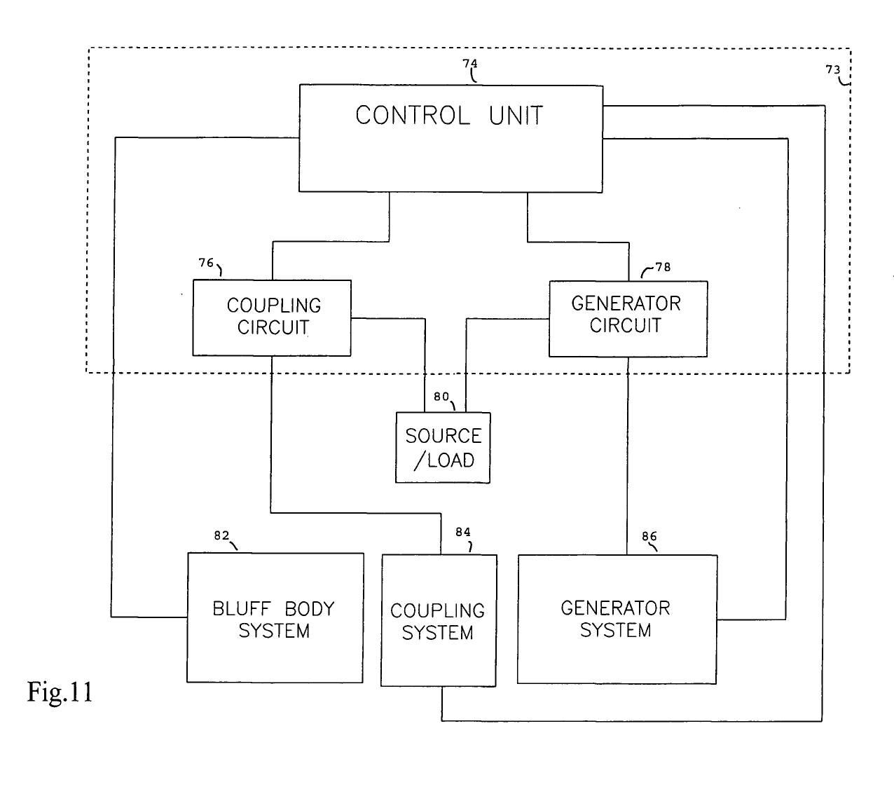

FIG. 11 is a block diagram of an electronic control system 73 which may be provided to manage the coupling between the bluff body system 82 and to manage the operating modes of the gyroscopic generator system 86, distributing power to or from the source/load 80. The control system 73 includes a control unit 74, a coupling circuit 76, and a generator circuit 78. In one exemplary embodiment of the systems and methods according to this invention, when a bluff body system 82 is placed in a fluid traveling at a given velocity the bluff body system 82 will oscillate at a relatively consistent frequency. The control unit 74 tracks the frequency of oscillation of the bluff body system 82. Simultaneously the control unit 74 tracks the rotational velocity of the gyroscope generator system 86. If the generator system 86 is out of phase from the bluff body system 82 the control system regulates the internal rotator rotational velocity to be proportional to that of the bluff body. This regulation is performed through the generator circuit 78 which either draws current from the generator system 86 and distributes it to the source/load 80 or draws current from the source/load 80 and distributes the power to the generator system 86, thereby reducing or increasing the rotational velocity of the internals of the generator system 86, respectively to match that of the bluff body system 82. If the generator system 86 and the bluff body system 82 are too far out of phase as determined by the control unit 74 the coupling system 84 may be disengaged by the coupling circuit 76 until their phases are close enough for the control unit 74 and hence the coupling circuit 76 to engage the coupling system 84. In various exemplary embodiments, the generator circuit 78 regulates the rotational velocity of the internals of the generator system 86 by switching its operating mode between motor and generator. The generator system 86 is operated as a motor when it is accelerated by the generator circuit 78 sending current from the source/load 80 to the internals of the generator system 86. The generator system 86 is operated as a generator when it is decelerated by the generator circuit 78 drawing current from the coiled wires internal of the generator system 86 and distributing it to the source/load 80. In various exemplary embodiments of the systems and methods of the invention, the torque energy passed from the oscillating bluff body system 82, through the power transmission coupling system 84 to the gyroscopic generator system 86 accelerates the internals of the generator system 86 and, simultaneously, the control system 73 draws an electric load from the internals of the generator system 86 that is equivalent to the increased rotational energy input as torque through the coupling system 84. In various exemplary embodiments, in steady state operation, the control system 73 distributes just as much energy from the generator system 86 to the source/load 80 as it realistically can from what is input from the fluid stream, equilibrating the path from fluid energy to electrical energy.

In another exemplary embodiment of the systems and methods of this invention, when a bluff body system 82 is placed in a fluid traveling at a given velocity the bluff body system 82 will oscillate at a relatively consistent frequency. The control system 73 tracks the frequency of oscillation of the bluff body system 82. Simultaneously the control system 73 tracks the rotational velocity of the gyroscope generator system 86. If the generator system 86 is out of phase from the bluff body system 82 the control system 73 regulates the flywheel 36 (internal to the generator system 86) rotational velocity to be proportional to that of the bluff body system 82. This regulation is performed by the control system 73 which either draws current from the generator system 86 and distributes it to the source/load 80 or draws current from the source/load 80 and distributes the power to the generator system 86, thereby reducing or increasing the rotational velocity of the generator system 86, respectively to match that of the bluff body system 82. If the generator system 86 and the bluff body system 82 are too far out of phase as determined by the control system 73 the coupling system 84 may be disengaged until their phases are close enough to engage the coupling system 84. In various exemplary embodiments, the control system 73 regulates the rotational velocity of the generator system 86 by switching its operating mode between motor and generator. The generator system 86 is operated as a motor when it is accelerated by the control system 73 sending current from the source/load 80 to the internals of the generator system 86. The generator system 86 is operated as a generator when it is decelerated by the control system 73 drawing current from the internals of the generator system 86 and distributing it to the source/load 80. In various exemplary embodiments of the systems and methods of the invention, the torque energy passed from the oscillating bluff body system 82, through the power transmission coupling system 84 to the gyroscopic generator system 86 accelerates the internals of the generator system 86 and, simultaneously, the control system 73 draws an electric load from the internals of the generator system 86 that is equivalent to the increased rotational energy input as torque through the coupling system 84. In various exemplary embodiments, in steady state operation, the control system 73 distributes just as much energy from the generator system 86 to the source/load 80 as it realistically can from what is input from the fluid stream, equilibrating the path from fluid energy to electrical energy.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for converting low velocity fluid flow into electrical energy by means of a von Karman Vortex, comprising:
a gyroscopic electrical generator;
a bluff body adapted to interact with the low velocity flowing fluid to generate a series of von Karman Vortex oscillating pressure gradients and for converting at least a portion of the energy in the flowing fluid to mechanical motion of the bluff body; and
means coupling the bluff body to the gyroscopic electrical generator to convert mechanical motion of the bluff body to the gyroscopic electrical generator for gyroscopically generating electrical energy.

2. A method for converting low velocity fluid flow into electrical energy by means of a von Karman Vortex, comprising:
interacting a bluff body with a low velocity flowing fluid to generate a series of von Karman Vortex oscillating pressure gradients and to convert at least a portion of the energy in the flowing fluid to mechanical motion of the bluff body;
coupling the bluff body to a gyroscopic electrical generator; and
converting mechanical motion of the bluff body to the gyroscopic electrical generator to gyroscopically generate electrical energy.

3. The system of claim 1, wherein the bluff body has a cylindrical shape.

4. The system of claim 1, wherein the bluff body has an airfoil shape.

5. The system of claim 1, wherein the bluff body has a trapezoidal shape.

6. The system of claim 1, wherein the bluff body has a disc shape.

7. The system of claim 1, wherein the bluff body has a spherical shape.

8. The system of claim 1, further comprising a splitter plate coupled to the bluff body.

9. The system of claim 6, wherein the splitter plate includes a plurality of plates.

10. The system of claim 1, further comprising an electromechanical support arm for converting mechanical deformation of the support arm into electricity.

11. The system of claim 1, further comprising a gyroscopic generator located in the bluff body.

12. The system of claim 1, further comprising a cable system and a flexible shaft for coupling motion of the bluff body to the gyroscopic electrical generator.

13. The system of claim 1, further comprising an additional electrical generator.

14. The system of claim 1, wherein the gyroscopic electrical generator comprises a plurality of gimbals.

15. The system of claim 1, further comprising a control system for managing operation of the gyroscopic electrical generator.

16. The system of claim 1, further comprising means for providing translational movement of the bluff body in a direction substantially perpendicular to the direction of flow of the low velocity fluid.
